(19) United States
(12) Patent Application Publication
(10) Pub. No.: US 2020/0018187 A1
(43) Pub. Date: Jan. 16, 2020

(54) ROTATING BODY AND TURBOCHARGER

(71) Applicant: IHI Corporation, Koto-ku (JP)

(72) Inventors: Ryota SAKISAKA, Tokyo (JP); Hikaru SUGIURA, Tokyo (JP)

(73) Assignee: IHI Corporation, Koto-ku (JP)

(21) Appl. No.: 16/571,812

(22) Filed: Sep. 16, 2019

Related U.S. Application Data
(63) Continuation of application No. PCT/JP2018/011219, filed on Mar. 20, 2018.

(30) Foreign Application Priority Data
Mar. 22, 2017 (JP) 2017-056116

(51) Int. Cl. F01D 25/24

(52) U.S. Cl. CPC F01D 25/24; F05D 2240/60; F05D 2220/40

(57) ABSTRACT

A rotating body includes: a protrusion provided on one of a turbine impeller and a shaft; and an insertion hole provided on the other one of the turbine impeller and the shaft, the insertion hole including a joint portion extending in a circumferential direction and joined to an outer circumferential surface of the protrusion, and a small inner diameter portion located closer to a tip side of the protrusion than the joint portion is, the small inner diameter portion receiving the protrusion entering therein.

### CROSS REFERENCE TO RELATED APPLICATIONS

This application is a continuation application of International Application No. PCT/JP2018/011219, filed on Mar. 20, 2018, which claims the priority based on Japanese Patent Application No. 2017-056116, filed on Mar. 22, 2017, the contents of which are incorporated herein by reference.

### BACKGROUND ART

### Technical Field

The present disclosure relates to a rotating body including a shaft and an impeller and a turbocharger.

### Related Art

In the related art, turbochargers in which a shaft is pivotally supported by a bearing housing are known. One end of the shaft is provided with a turbine impeller. The other end of the shaft is provided with a compressor impeller. The turbocharger is connected to an engine. The turbine impeller rotates by exhaust gas discharged from the engine. The rotation of the turbine impeller causes the compressor impeller to rotate via the shaft. The turbocharger compresses and delivers the air to the engine as the compressor impeller rotates.

In Patent Literature 1, a joint structure of an impeller and a shaft is described. A ceramic shaft is integrally molded with an impeller. An insertion portion of the ceramic shaft is inserted into a cylindrical portion of a metal shaft. An electromagnetic coil is disposed on the outer periphery of the cylindrical portion. When a large current flows in the electromagnetic coil, a magnetic flux and an eddy current flow in the cylindrical portion. By the electromagnetic force, the diameter is reduced such that the cylindrical portion is brought into close contact with the insertion portion. In this manner, the ceramic shaft and the metal shaft are joined.

### CITATION LIST

### Patent Literature

Patent Literature 1: Japanese Patent No. 2569708

### SUMMARY

### Technical Problem

In the configuration described in the above Patent Literature 1, along with the deformation of the cylindrical portion at the time of joining, the positions in the radial direction of the ceramic shaft or the impeller and the metal shaft are disadvantageously shifted.

An object of the present disclosure is to provide a rotating body and a turbocharger capable of improving the accuracy in radial positioning of a shaft and an impeller.

### Solution to Problem

In order to solve the above disadvantage, a rotating body according to an aspect of the present disclosure includes: a protrusion provided on one of an impeller and a shaft; and an insertion hole provided on the other one of the impeller and the shaft, the insertion hole including a joint portion extending in a circumferential direction and joined to an outer circumferential surface of the protrusion, and an entry portion located closer to a tip side of the protrusion than the joint portion is, the entry portion receiving the protrusion entering therein.

The joint portion and the entry portion may have different inner diameters.

An expanding diameter portion formed on an inner surface of the insertion hole continuously with the joint portion may be further included, the expanding diameter portion having a diameter expanding outward in a radial direction of the shaft and separated more from the outer circumferential surface of the protrusion as the expanding diameter portion extends away from the joint portion.

A portion of an outer wall of the insertion hole where the joint portion and the expanding diameter portion are formed on the inner surface may extend longer in an axial direction of the shaft than a thickness in the radial direction of the shaft.

An abutment portion provided in the insertion hole and extending in the radial direction of the shaft and a contact portion formed in the protrusion and contacting the abutment portion in the axial direction of the shaft may be further included.

The abutment portion may be provided between the joint portion and the entry portion.

An outer diameter of a portion of the protrusion located radially inward from the entry portion may be larger than an outer diameter of a portion having the smallest diameter in a portion located radially inward from the joint portion.

In order to solve the above disadvantage, a turbocharger according to an aspect of the present disclosure includes the rotating body described above.

### Effects of Disclosure

According to the present disclosure, it is possible to improve the accuracy in radial positioning of a shaft and an impeller.

### BRIEF DESCRIPTION OF DRAWINGS

FIG. 1 is a schematic cross-sectional view of a turbocharger.

FIG. 2 is an explanatory view for explaining a turbine shaft (rotating body).

FIG. 3A is an extracted view of a broken line part in FIG. 2. FIG. 3B is an extracted view of a two-dot chain line part in FIG. 3A.

FIG. 4A is a view before a shaft and a turbine impeller are joined. FIG. 4B is a view after the shaft and the turbine impeller are joined. FIG. 4C is a partial enlarged view of a joint surface of the shaft and the turbine impeller.

FIG. 5A is an extracted view of a part corresponding to FIG. 3A in a first modification. FIG. 5B is an extracted view of a two-dot chain line part in FIG. 5A in the first modification.

FIG. 6A is an extracted view of a part corresponding to FIG. 3A in a second modification. FIG. 6B is an extracted view of a two-dot chain line part in FIG. 6A in the second modification.

FIG. 7A is an extracted view of a part corresponding to FIG. 3A in a third modification. FIG. 7B is an extracted view of a two-dot chain line part in FIG. 7A in the third modification.

### DESCRIPTION OF EMBODIMENTS

An embodiment of the present disclosure will be described in detail below with reference to the accompanying drawings. Dimensions, materials, other specific numerical values, and the like illustrated in the embodiment are merely examples for facilitating understanding of the invention, and the present disclosure is not limited thereby unless specifically mentioned otherwise. Note that, in the present specification and the drawings, components having substantially the same function and structure are denoted by the same symbol, and redundant explanation is omitted. Components not directly related to the present disclosure are not illustrated.

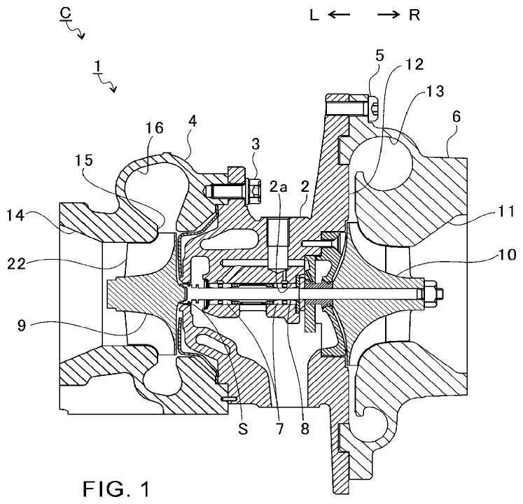

FIG. 1 is a schematic cross-sectional view of a turbocharger C. Hereinafter, description is given assuming that a direction of an arrow L illustrated in FIG. 1 is the left side of the turbocharger C. Description is given assuming that a direction of an arrow R illustrated in FIG. 1 is the right side of the turbocharger C. As illustrated in FIG. 1, the turbocharger C includes a turbocharger main body 1. The turbocharger main body 1 includes a bearing housing 2. A turbine housing 4 is connected to the left side of the bearing housing 2 by a fastening bolt 3. A compressor housing 6 is connected to the right side of the bearing housing 2 by a fastening bolt 5.

A bearing hole 2a is formed in the bearing housing 2. The bearing hole 2a penetrates through the turbocharger C in the left-right direction. A bearing 7 is provided in the bearing hole 2a. In FIG. 1, a full-floating bearing is illustrated as an example of the bearing 7. However, the bearing 7 may be another radial bearing such as a semi-floating bearing or a rolling bearing. A shaft 8 is pivotally supported by the bearing 7. At the left end of the shaft 8, a turbine impeller 9 (impeller) is provided. The turbine impeller 9 is accommodated in the turbine housing 4 in a freely rotatable manner. At the right end of the shaft 8, a compressor impeller 10 is provided. The compressor Impeller 10 is accommodated in the compressor housing 6 in a freely rotatable manner.

An intake port 11 is formed in the compressor housing 6. The intake port 11 opens to the right side of the turbocharger C. The intake port 11 is connected to an air cleaner (not illustrated). Furthermore, in a state in which the bearing housing 2 and the compressor housing 6 are connected by the fastening bolt 5 as described above, a diffuser flow passage 12 is formed. The diffuser flow passage 12 is formed by opposing surfaces of the bearing housing 2 and the compressor housing 6. The diffuser flow passage 12 pressurizes the air. The diffuser flow passage 12 is annularly formed outward from an inner side in the radial direction of the shaft 8. The diffuser flow passage 12 communicates with the intake port 11 via the compressor impeller 10 on the inner side in the radial direction.

Furthermore, the compressor housing 6 is provided with a compressor scroll flow passage 13. The compressor scroll flow passage 13 is annular. The compressor scroll flow passage 13 is positioned on an outer side in the radial direction of the shaft 8 with respect to the diffuser flow passage 12. The compressor scroll flow passage 13 communicates with an intake port of the engine (not illustrated). The compressor scroll flow passage 13 also communicates with the diffuser flow passage 12. When the compressor impeller 10 rotates, the air is sucked from the intake port 11 into the compressor housing 6. The intake air flows between blades of the compressor impeller 10. In this process, the air is pressurized and accelerated by the action of centrifugal force. The pressurized and accelerated air is pressurized by the diffuser flow passage 12 and the compressor scroll flow passage 13. The pressurized air is guided to the intake port of the engine.

A discharge port 14 is formed in the turbine housing 4. The discharge port 14 opens to the left side of the turbocharger C. The discharge port 14 is connected to an exhaust gas purification device (not illustrated). The turbine housing 4 is further provided with a flow passage 15 and a turbine scroll flow passage 16. The turbine scroll flow passage 16 is annular. The turbine scroll flow passage 16 is positioned on an outer side in the radial direction of the turbine impeller 9 with respect to the flow passage 15. The turbine scroll flow passage 16 communicates with a gas inlet port (not illustrated). Exhaust gas discharged from an exhaust manifold of the engine (not illustrated) is guided into the gas inlet port. The gas inlet port also communicates with the above flow passage 15. Therefore, the exhaust gas guided from the gas inlet port to the turbine scroll flow passage 16 is guided to the discharge port 14 via the flow passage 15 and between the blades of the turbine impeller 9 (between multiple blades 22 which will be described later). The exhaust gas guided to the discharge port 14 rotates the turbine impeller 9 in the process of flowing therethrough.

The turning force of the turbine impeller 9 is further transmitted to the compressor impeller 10 via the shaft 8. As described above, the air is pressurized by the turning force of the compressor impeller 10 and is guided into the intake port of the engine.

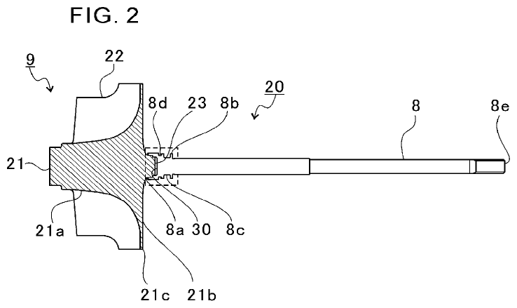

FIG. 2 is an explanatory view for explaining a turbine shaft 20 (rotating body). As illustrated in FIG. 2, the turbine shaft 20 includes the shaft 8 and the turbine impeller 9. The turbine impeller 9 is, for example, a radial type. The diameter of a main body portion 21 (hub portion) of the turbine impeller 9 expands in the axial direction of the shaft 8 (that is, the rotational axis direction of the turbine shaft 20, hereinafter simply referred to as the axial direction) from left to right in FIG. 2.

An outer circumferential surface 21a of the main body portion 21 is exposed on one side in the rotational axis direction. A back surface 21b of the main body portion 21 is exposed on the other side in the rotational axis direction. The external shapes of the outer circumferential surface 21a and the back surface 21b when viewed in the rotational axis direction are, for example, round. The outer diameter of the outer circumferential surface 21a of the main body portion 21 gradually increases toward the other side in the rotational axis direction. On the outer circumferential surface 21a, a plurality of blades 22 is provided. The multiple blades 22 are spaced apart from each other in the circumferential direction of the outer circumferential surface 21a. The plurality of blades 22 projects radially outward from the outer circumferential surface 21a.

A slinger 8b is formed on the shaft 8 on the turbine impeller 9 side (on one end 8a side in the axial direction). The slinger 8b protrudes radially outward from an outer circumferential surface 8c of the shaft 8. The slinger 8b scatters lubricating oil having lubricated the bearing 7 radially outward by centrifugal force.

A sealing groove 8d is formed on the shaft 8 on the one end 8a side with respect to the slinger 8b. A sealing ring S (see FIG. 1) is accommodated in the sealing groove 8d. The sealing ring S suppresses the inflow of the lubricating oil from the bearing 7 side to the turbine impeller 9 side.

A protrusion 23 is formed at the center of the back surface 21b of the main body portion 21. The protrusion 23 protrudes in the axial direction from the back surface 21b. An insertion hole 30 is formed at the one end 8a of the shaft 8. The insertion hole 30 is recessed from the one end 8a in the axial direction toward the other end 8e side. The protrusion 23 is inserted in the insertion hole 30.

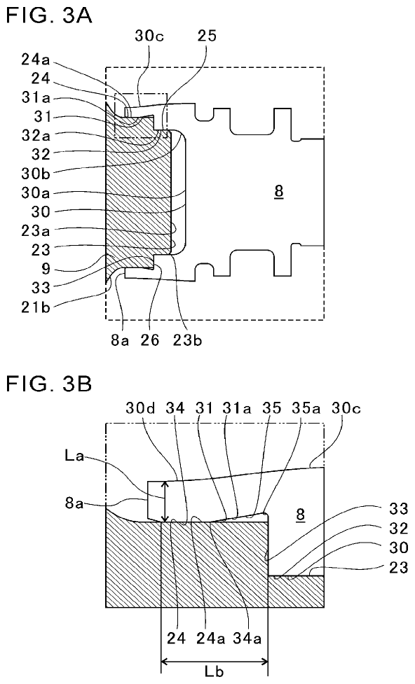

FIG. 3A is an extracted view of a broken line part in FIG. 2. FIG. 3B is an extracted view of a two-dot chain line part in FIG. 3A. As illustrated in FIG. 3A, the protrusion 23 is provided with a large diameter portion 24, a small diameter portion 25, and a contact portion 26. The large diameter portion 24 is located on the base end side (back surface 21b side) of the protrusion 23. The large diameter portion 24 extends in the axial direction and in the circumferential direction. The small diameter portion 25 is located closer to a tip 23a side (a side away from the back surface 21b) than the large diameter portion 24 is in the protrusion 23. The small diameter portion 25 extends in the axial direction and in the circumferential direction. The outer diameter of the large diameter portion 24 is larger than the outer diameter of the small diameter portion 25.

The contact portion 26 is a surface continuous with the large diameter portion 24 and the small diameter portion 25. The contact portion 26 extends perpendicularly to the axial direction. The tip 23a of the protrusion 23 (small diameter portion 25) is a surface extending perpendicularly to the axial direction. A tapered surface 23b is formed on the outer peripheral edge of the tip 23a.

The insertion hole 30 is provided with a large inner diameter portion 31, a small inner diameter portion 32 (entry portion), and an abutment portion 33. The large inner diameter portion 31 is provided in the insertion hole 30 on the base end side of the protrusion 23 (on the one end 8a side of the shaft 8). The small inner diameter portion 32 is provided on the tip 23a side of the protrusion 23 with respect to the large inner diameter portion 31 (on a bottom surface 30a side of the insertion hole 30, the other end 8e side of the shaft 8). The small inner diameter portion 32 extends in the axial direction and the circumferential direction. The inner diameter of the large inner diameter portion 31 is larger than the inner diameter of the small inner diameter portion 32.

The abutment portion 33 is a surface continuous with the large inner diameter portion 31 and the small inner diameter portion 32. The abutment portion 33 extends perpendicularly to the axial direction. The bottom surface 30a of the insertion hole 30 extends perpendicularly to the axial direction. A curved surface 30b is formed on the outer periphery of the bottom surface 30a. The center of curvature of the curved surface 30b is located on the insertion hole 30 side (on the tip 23a side of the protrusion 23 and on the center side of the shaft 8) with respect to the curved surface 30b.

The small diameter portion 25 of the protrusion 23 enters the small inner diameter portion 32 of the insertion hole 30 and is fitted in any of an interference fit, a transition fit, or a clearance fit. For example in the case where the fitting between the small diameter portion 25 and the small inner diameter portion 32 is an interference fit or a transition fit, the small diameter portion 25 may be press-fit into the small inner diameter portion 32. The turbine impeller 9 and the shaft 8 are positioned in the radial direction of the shaft 8 by the small diameter portion 25 and the small inner diameter portion 32.

The contact portion 26 of the protrusion 23 abuts against the abutment portion 33 of the insertion hole 30 in the axial direction. Therefore, the turbine impeller 9 and the shaft 8 are positioned in the axial direction of the shaft 8 by the contact portion 26 and the abutment portion 33.

As illustrated in FIG. 3B, on an inner circumferential surface 31a of the large inner diameter portion 31 (inner surface of the insertion hole 30), a joint portion 34 and an expanding diameter portion 35 are provided. The joint portion 34 is provided in the large inner diameter portion 31 on the one end 8a side of the shaft 8. The joint portion 34 extends in the axial direction and the circumferential direction. A notch (not illustrated) is formed in the large inner diameter portion 31 at the one end 8a side of the shaft 8 such that the protrusion 23 can be easily inserted into the insertion hole 30. The joint portion 34 may extend to the end of the large inner diameter portion 31 on the one end 8a side of the shaft 8 without providing the notch.

The joint portion 34 has a larger inner diameter than that of the small inner diameter portion 32. The joint portion 34 is joined to an outer circumferential surface 24a of the large diameter portion 24 of the protrusion 23. The abutment portion 33 above is provided between the joint portion 34 and the small inner diameter portion 32.

The expanding diameter portion 35 is provided in the large inner diameter portion 31 on the abutment portion 33 side (on the other end 8e side of the shaft 8). The expanding diameter portion 35 is continuous with an end 34a of the joint portion 34 on the abutment portion 33 side. The diameter of the expanding diameter portion 35 expands outward in the radial direction of the shaft 8 as the expanding diameter portion 35 extends away from the joint portion 34. The inner diameter of the expanding diameter portion 35 becomes larger as the expanding diameter portion 35 extends toward the abutment portion 33. The expanding diameter portion 35 is separated more from the outer circumferential surface 24a of the large diameter portion 24 as the expanding diameter portion extends away from the joint portion 34. The end of the expanding diameter portion 35 on the abutment portion 33 side is a curved surface 35a. The curved surface 35a is continuous with the abutment portion 33. The center of curvature of the curved surface 35a is located on the insertion hole 30 side (on the large diameter portion 24 side, the center side of the shaft 8) with respect to the curved surface 35a.

Of the outer wall 30c of the insertion hole 30, let the thickness in the radial direction of the shaft 8 of an outer wall 30d of the large inner diameter portion 31 (that is, a portion where the joint portion 34 and the expanding diameter portion 35 are formed on the inner circumferential surface 31a) be a thickness La. Of the outer wall 30d of the large inner diameter portion 31, the length in the axial direction of the shaft 8 is denoted as a length Lb. The length Lb of the outer wall 30d is longer than a thickness La.

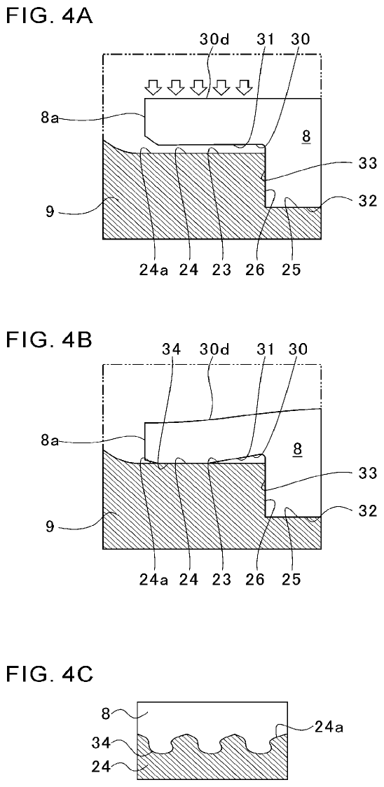

FIG. 4A is a view before the shaft 8 and the turbine impeller 9 are joined. FIG. 4B is a view after the shaft 8 and the turbine impeller 9 are joined. FIG. 4C is a partial enlarged view of a joint surface of the shaft 8 and the turbine impeller 9. In FIG. 4C, the joint surface between the shaft 8 and the compressor impeller 10 is illustrated in a simplified manner. As illustrated in FIG. 4A, a predetermined clearance (gap) is provided between the large inner diameter portion 31 and the outer circumferential surface 24a of the large diameter portion 24 before joining. In the manufacturing process of the turbine shaft 20, the protrusion 23 of the turbine impeller 9 is inserted into the insertion hole 30 of the shaft 8. The small diameter portion 25 of the protrusion 23 is fitted to the small inner diameter portion 32 of the insertion hole 30. The contact portion 26 of the protrusion 23 contacts the abutment portion 33 of the insertion hole 30. In this manner, radial and axial positioning of the shaft 8 and the turbine impeller 9 is performed. Here, the clearance provided between the large inner diameter portion 31 and the outer circumferential surface 24a of the large diameter portion 24 may be set larger than a gap provided between the small diameter portion 25 and the small inner diameter portion 32 in the case of a clearance fit or a transition fit.

Then, the outer wall 30d of the insertion hole 30 is inserted into a coil (not illustrated). When a large current flows in the coil, a magnetic flux and an eddy current flow in the outer wall 30d by electromagnetic induction. The electromagnetic force repulses between the coil and the outer wall 30d, and an electromagnetic force (indicated by white arrows in FIG. 4A) acts radially inward on the outer wall 30d. The diameter of the outer wall 30d is reduced at high speed sequentially from the one end 8a side of the shaft 8 (the base end side of the protrusion 23) toward the right side (the abutment portion 33 side) in FIG. 4A. The joint portion 34 collides with the outer circumferential surface 24a of the large diameter portion 24 at high speed.

As a result, as illustrated in FIG. 4B, the joint portion 34 is welded (joined) to the outer circumferential surface 24a of the large diameter portion 24. In this manner, when the turbine impeller 9 and the shaft 8 are welded by electromagnetic forming, metals collide at high speed. Therefore, a fluid-like behavior (viscoplasticity behavior) occurs at the joint surface. As a result, as illustrated in FIG. 4C, the joint portion 34 and the outer circumferential surface 24a of the large diameter portion 24 are joined at the atomic level. For example, the joint surface has a corrugated shape. Here, as an example, the case where the joint portion 34 is welded to the outer circumferential surface 24a of the large diameter portion 24 by electromagnetic forming has been explained. However, the joint portion 34 and the outer circumferential surface 24a of the large diameter portion 24 may be joined by another joining processing such as explosive bonding.

For example, when the joint portion is welded to a surface perpendicular to the axial direction of the shaft 8, heat shrinkage during cooling causes displacement in the axial direction. As described above, the joint portion 34 is joined from the radially outer side to the outer circumferential surface 24a of the large diameter portion 24 (for example, the joint portion 34 extends in the axial direction). In this case, even if heat shrinkage occurs, since the positional misalignment in the axial direction is unlikely to occur, the dimensional accuracy is improved. Moreover, for example by extending the joint portion 34 in the axial direction, the joint area can be expanded without increasing the outer diameter.

Furthermore, the small inner diameter portion 32 positions the turbine impeller 9 and the shaft 8 in the radial direction. Therefore, even in the case where joining processing is performed such as electromagnetic forming, it is unlikely that the turbine impeller 9 and the shaft 8 are misaligned in the radial direction.

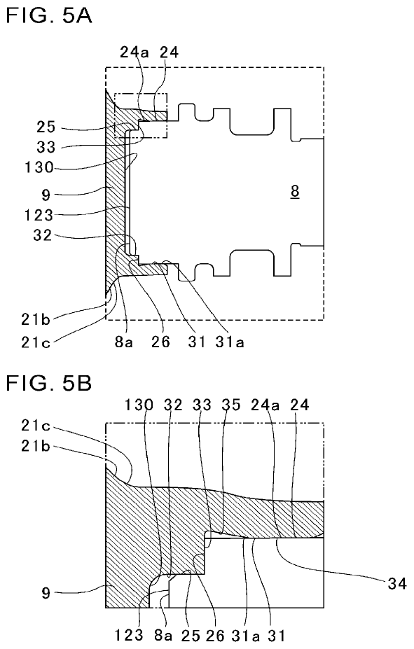

FIG. 5A is an extracted view of a part corresponding to FIG. 3A in a first modification. FIG. 5B is an extracted view of a two-dot chain line part in FIG. 5A in the first modification. As illustrated in FIG. 5A, in the first modification, a protrusion 123 is provided at one end 8a of a shaft 8. In addition, a raised portion 21c is formed on a back surface 21b of a turbine impeller 9. The raised portion 21c is raised toward the shaft 8. An insertion hole 130 is provided in the raised portion 21c of the turbine impeller 9. In this example, the case where the raised portion 21c is formed on the back surface 21b of the turbine impeller 9 has been described. However, the shape of the back surface 21b of the turbine impeller 9 is not limited to this. For example, the insertion hole 130 may be formed on the back surface 21b of the turbine impeller 9 without forming the raised portion 21c.

Like in the embodiment described above, the protrusion 123 is provided with a large diameter portion 24, a small diameter portion 25, and a contact portion 26. The insertion hole 130 is provided with a large inner diameter portion 31, a small inner diameter portion 32 (entry portion), and an abutment portion 33. The protrusion 123 enters the insertion hole 130 (small inner diameter portion 32). As illustrated in FIG. 5B, on an inner circumferential surface 31a of the large inner diameter portion 31 (inner surface of the insertion hole 130), a joint portion 34 and an expanding diameter portion 35 are provided. For example, the joint portion 34 is welded to an outer circumferential surface 24a of the large diameter portion 24 by electromagnetic forming. The first modification has a substantially equivalent configuration to the above-described embodiment except that the arrangement of the protrusion 123 and the insertion hole 130 is different. Here, the detailed description is omitted in order to avoid repeated description.

Also in the first modification, positional misalignment of the turbine impeller 9 and the shaft 8 in the axial direction is unlikely to occur like in the embodiment described above, and the dimensional accuracy is improved. For example by extending the joint portion 34 in the axial direction, the joint area can be expanded without increasing the outer diameter. The small inner diameter portion 32 positions the turbine impeller 9 and the shaft 8 in the radial direction. Therefore, even in the case where joining processing is performed such as electromagnetic forming, it is unlikely that the turbine impeller 9 and the shaft 8 are misaligned in the radial direction.

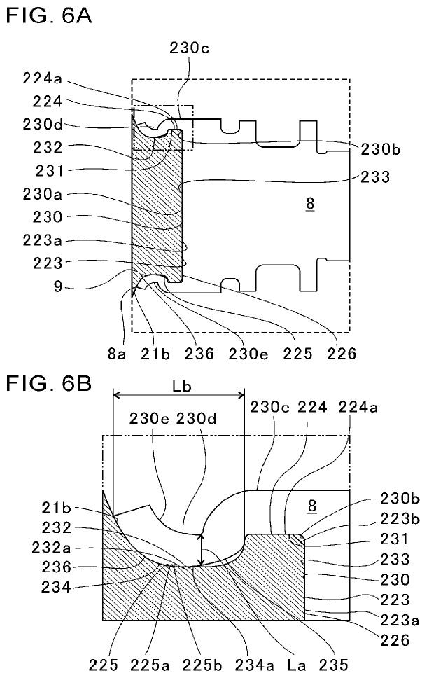

FIG. 6A is an extracted view of a part corresponding to FIG. 3A in a second modification. FIG. 6B is an extracted view of a two-dot chain line part in FIG. 6A in the second modification. In the second modification, as illustrated in FIG. 6A, a protrusion 223 is formed at the center of a back surface 21b of a turbine impeller 9 like in the embodiment described above. An insertion hole 230 is formed at one end 8a of a shaft 8.

The protrusion 223 is provided with a large diameter portion 224, a small diameter portion 225, and a contact portion 226. The large diameter portion 224 is located on a tip 223a side of the protrusion 223 (a side away from the back surface 21b side). The large diameter portion 224 extends in the axial direction and in the circumferential direction. The small diameter portion 225 is located closer to the base end side (back surface 21b side) of the protrusion 223 than the large diameter portion 224 is. The small diameter portion 225 extends in the axial direction and in the circumferential direction. The outer diameter of the large diameter portion 224 is larger than the outer diameter of the small diameter portion 225.

The contact portion 226 is a tip surface located at a tip 223a of the protrusion 223. The contact portion 226 extends perpendicularly to the axial direction. A tapered surface 223b is formed on the outer periphery of the tip 223a (see FIG. 6B). The insertion hole 230 is provided with a large inner diameter portion 231 (entry portion), a small inner diameter portion 232, and an abutment portion 233. The protrusion 223 enters the insertion hole 230 (large inner diameter portion 231). The large inner diameter portion 231 is provided in the insertion hole 230 on the tip 223a side of the protrusion 223 (on a bottom surface 230a side of the insertion hole 230, the other end 8e side of the shaft 8). The small inner diameter portion 232 is provided closer to the base end side of the protrusion 223 (the one end 8a side of the shaft 8) than the large inner diameter portion 231 is. The small inner diameter portion 232 extends in the axial direction and the circumferential direction. The inner diameter of the large inner diameter portion 231 is larger than the inner diameter of the small inner diameter portion 232.

A curved surface 236 is formed in the small inner diameter portion 232 on the back surface 21b side of the turbine impeller 9. The diameter of the curved surface 236 expands radially outward along the back surface 21b toward the back surface 21b of the turbine impeller 9.

Of an outer wall 230c of the insertion hole 230, an outer wall 230d of the small inner diameter portion 232 is recessed radially inward. Of the outer wall 230c of the insertion hole 230, the diameter of an outer wall 230e of the curved surface 236 expands radially outward toward the back surface 21b. For example, the outer wall 230e may have a curved shape corresponding to the curved surface 236.

The abutment portion 233 is the bottom surface 230a of the insertion hole 230. The abutment portion 233 extends perpendicularly to the axial direction. A curved surface 230b is formed on the outer periphery of the bottom surface 230a (see FIG. 6B). The center of curvature of the curved surface 230b is located on the insertion hole 230 side (on the tip 223a side of the protrusion 223 and on the center side of the shaft 8) with respect to the curved surface 230b.

The large diameter portion 224 of the protrusion 223 is, for example, press-fit or clearance-fit to the large inner diameter portion 231 of the insertion hole 230. The turbine impeller 9 and the shaft 8 are positioned in the radial direction of the shaft 8 by the large diameter portion 224 and the large inner diameter portion 231.

The contact portion 226 of the protrusion 223 abuts against the abutment portion 233 of the insertion hole 230 in the axial direction. Therefore, the turbine impeller 9 and the shaft 8 are positioned in the axial direction of the shaft 8 by the contact portion 226 and the abutment portion 233.

As illustrated in FIG. 6B, a joint portion 234 is provided on an inner circumferential surface 232a of the small inner diameter portion 232 and the curved surface 236 (inner surface of the insertion hole 230). The joint portion 234 is provided across the curved surface 236 and a part of the inner circumferential surface 232a of the small inner diameter portion 232.

The joint portion 234 extends in the circumferential direction. At least a part of the joint portion 234 extends in the axial direction. The joint portion 234 has a smaller inner diameter than that of the large inner diameter portion 231. The joint portion 234 is joined to the small diameter portion 225 of the protrusion 223 and a part of the back surface 21b.

An expanding diameter portion 235 is provided in the small inner diameter portion 232 on the abutment portion 233 side (on the other end 8e side of the shaft 8). The expanding diameter portion 235 is continuous with an end 234a of the joint portion 234 on the abutment portion 233 side. The diameter of the expanding diameter portion 235 expands outward in the radial direction of the shaft 8 as the expanding diameter portion 235 extends away from the joint portion 234. The inner diameter of the expanding diameter portion 235 becomes larger as the expanding diameter portion 235 extends toward the abutment portion 233. The expanding diameter portion 235 is separated more from an outer circumferential surface 225a of the small diameter portion 225 as the expanding diameter portion 235 extends away from the joint portion 234.

Of the outer walls 230d and 230e of the insertion hole 230 (portions where the joint portion 234 and the expanding diameter portion 235 are formed on the inner circumferential surface), let the thickness in the radial direction of the shaft 8 at any position be thickness La. Let the axial length of the outer walls 230d and 230e of the insertion hole 230 be length Lb. The axial length Lb of the outer walls 230d and 230e is longer than the thickness La.

Also in the second modification, positional misalignment of the turbine impeller 9 and the shaft 8 in the axial direction is unlikely to occur like in the embodiment described above, and the dimensional accuracy is improved. For example by extending the joint portion 234 in the axial direction, the joint area can be expanded without increasing the outer diameter. Since the radial positioning of the turbine impeller 9 and the shaft 8 is performed by the large inner diameter portion 231, even in the case where joining processing is performed such as electromagnetic forming, it is unlikely that the turbine impeller 9 and the shaft 8 are misaligned in the radial direction.

Moreover, in the second modification, the protrusion 223 is caulked by the outer wall 230c of the insertion hole 230. Therefore, in addition to joining by the joint portion 234, the caulked portion functions as, for example, a retainer of the joint portion 234. As a result, the reliability of the joint portion 234 can be improved. Furthermore, the outer diameter of the large diameter portion 224 (portion located radially inward from the large inner diameter portion 231) of the protrusion 223 is larger than the outer diameter of a smallest diameter portion 225b having the smallest diameter in the small diameter portion 225 (portion located radially inward from the joint portion 234). Therefore, since the radial positioning is performed by the large diameter portion 224 in the joining processing, the outer wall 230c of the insertion hole 230 is caulked with good accuracy. Since the distance between the large diameter portion 224 and the caulking portion in the axial direction is short, the accuracy is further improved.

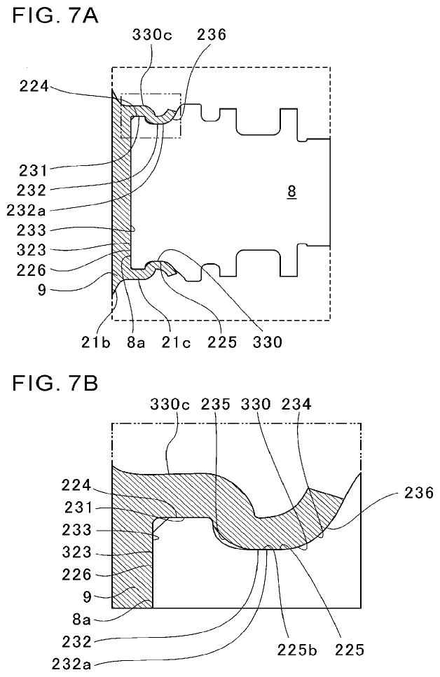

FIG. 7A is an extracted view of a part corresponding to FIG. 3A in a third modification. FIG. 7B is an extracted view of a two-dot chain line part in FIG. 7A in the third modification. As illustrated in FIG. 7A, in the third modification, a protrusion 323 is provided at one end 8a of a shaft 8 like in the second modification. In addition, a raised portion 21c is formed on a back surface 21b of a turbine impeller 9. An insertion hole 330 is provided in the raised portion 21c of the turbine impeller 9.

Like in the second modification described above, the protrusion 323 is provided with a large diameter portion 224, a small diameter portion 225, and a contact portion 226. The insertion hole 330 is provided with a large inner diameter portion 231 (entry portion), a small inner diameter portion 232, and an abutment portion 233. The protrusion 323 enters the insertion hole 330 (large inner diameter portion 231). A joint portion 234 is provided on an inner circumferential surface 232a of the small inner diameter portion 232 and a curved surface 236 (inner surface of the insertion hole 230).

An expanding diameter portion 235 is provided in the small inner diameter portion 232 on the abutment portion 233 side (on one end 8a side of the shaft 8). The third modification has a substantially equivalent configuration to the above-described second modification except that the arrangement of the protrusion 323 and the insertion hole 330 is different. Here, the detailed description is omitted in order to avoid repeated description.

Also in the third modification, positional misalignment of the turbine impeller 9 and the shaft 8 in the axial direction is unlikely to occur like in the embodiment described above, and the dimensional accuracy is improved. For example by extending the joint portion 234 in the axial direction, the joint area can be expanded without increasing the outer diameter. Since the radial positioning of the turbine impeller 9 and the shaft 8 is performed by the large inner diameter portion 231, even in the case where joining processing is performed such as electromagnetic forming, it is unlikely that the turbine impeller 9 and the shaft 8 are misaligned in the radial direction.

Moreover, like in the second modification described above, the protrusion 323 is caulked by the outer wall 330c of the insertion hole 330. Therefore, in addition to the joining by the joint portion 234, the joining strength can be improved by caulking. Of the protrusion 323, the outer diameter of the large diameter portion 224 is larger than the outer diameter of the smallest diameter portion 225b. Since the radial positioning is performed by the large diameter portion 224, the outer wall 330c of the insertion hole 330 is caulked with good accuracy. Since the distance between the large diameter portion 224 and the caulking portion in the axial direction is short, the accuracy is further improved.

Although an embodiment of the present disclosure has been described with reference to the accompanying drawings, it is naturally understood that the present disclosure is not limited to the above embodiment. It is clear that those skilled in the art can conceive various modifications or variations within the scope described in the claims, and it is understood that they are naturally also within the technical scope of the present disclosure.

For example in the embodiment and the modifications described above, the case where electromagnetic forming is used as the joining processing has been described. However, electromagnetic forming is merely an example, and other joining processing may be used. In the case where electromagnetic forming is used, less heat is generated during joining. Therefore, residual stress due to heat is suppressed. Moreover, it is unlikely that a region affected by heat input by welding is generated at the boundary of the joint portions 34 and 234 between the shaft 8 and the turbine impeller 9 unlike in the case of electron beam welding or laser beam welding, for example. Therefore, the joining strength is improved.

The materials of the shaft 8 and the turbine impeller 9 are not limited. For example in the case where electromagnetic forming is used, it is possible that the members provided with the protrusions 23, 123, 223, and 323 are made of a titanium (Ti)-based alloy and that the members provided with the insertion holes 30, 130, 230, and 330 are made of an iron (Fe)-based alloy. Alternatively, it is possible that the members provided with the protrusions 23, 123, 223, and 323 are made of an iron (Fe)-based alloy and that the members provided with the insertion holes 30, 130, 230, and 330 are made of a nickel (Ni)-based alloy. These are combinations of metals in which the electrical resistance of a metal that is colliding is smaller than that of a collided metal. Therefore, a colliding metal is easily deformed at high speed and is easily joined by electromagnetic forming. In other words, in the case of electromagnetic forming, joining is easily performed with a combination of a colliding metal having a higher conductivity (electrical conductivity) than that of a metal to be collided. In addition, in a case where joining by electromagnetic forming is not considered, it is possible from the viewpoint of performance such as strength in the turbocharger C that the turbine impeller 9 is made of a titanium (Ti)-based alloy or a nickel (Ni)-based alloy and that the shaft 8 is made of an iron (Fe)-based alloy. That is, in the case where electromagnetic forming is used in the turbocharger C, it is possible that the turbine impellers 9 provided with the protrusions 23 and 223 are made of a titanium (Ti)-based alloy and that the shafts 8 provided with the insertion holes 30 and 230 are made of an iron (Fe)-based alloy. It is possible that the shafts 8 provided with the protrusions 123 and 323 are made of an iron (Fe)-based alloy and that the turbine impellers 9 provided with the insertion holes 130 and 330 are made of a nickel (Ni)-based alloy. These materials are merely examples, and the embodiment and the modifications described above are not limited to structures using these materials.

In the embodiment and the modifications described above, the cases where the inner diameter of the joint portions 34 and 234 and the inner diameter of the entry portion (small inner diameter portion 32 or large inner diameter portion 231) are different have been described. However, the inner diameter of the joint portions 34 and 234 may be the same as the inner diameter of the entry portion (small inner diameter portion 32 or large inner diameter portion 231).

In the embodiment and the modifications described above, the cases where the expanding diameter portions 35 and 235 are provided have been explained. In these cases, stress concentration on the joint portions 34 and 234 is alleviated. However, the expanding diameter portion 35 or 235 may not be provided.

Furthermore, in the embodiment and the modifications described above, the cases where the length Lb of the outer wall 30d or the outer walls 230d and 230e is longer than the thickness La have been described. In this case, in the joining processing such as electromagnetic forming, the joint portions 34 and 234 that are the colliding side are easily deformed at high speed and are easily joined by electromagnetic forming. However, the length Lb of the outer wall 30d or the outer walls 230d and 230e may be the same as or shorter than the thickness La.

In the embodiment and the modifications described above, the cases where the abutment portions 33 and 233 and the contact portions 26 and 226 are provided have been explained. However, the abutment portions 33 and 233 and the contact portions 26 and 226 are not essential components.

Moreover, in the second and third modifications described above, the cases where the outer diameter of the large diameter portion 224 is larger than the outer diameter of the smallest diameter portion 225b have been described. However, the outer diameter of the large diameter portion 224 may be equal to or less than the outer diameter of the smallest diameter portion 225b.

Furthermore in the embodiment and the modifications described above, the turbine shaft 20 provided in the turbocharger C has been explained as an example as a rotating body. However, the rotating body is only required to include at least a shaft and an impeller, and the rotating body may be provided in another turbine or a compressor such as a gas turbine or a general-purpose compressor.

In the embodiment described above, the case where the outer circumferential surface 21a and the back surface 21b of the turbine impeller 9 have a round outer shape when viewed in the axial direction has been described; however, the present disclosure is not limited thereto. For example, the back surface 21b may not be round (full disk). A notch (scallop) may be provided between the multiple blades 22 on the back surface 21b.

### INDUSTRIAL APPLICABILITY

The present disclosure can be applied to a rotating body including a shaft and an impeller and to a turbocharger.

What is claimed is:

1. A rotating body comprising:
a protrusion provided on one of an impeller and a shaft;
an insertion hole provided on another one of the impeller and the shaft, the insertion hole including a joint portion extending in a circumferential direction and joined to an outer circumferential surface of the protrusion, and an entry portion located closer to a tip side of the protrusion than the joint portion is, the entry portion receiving the protrusion entering therein; and
an expanding diameter portion formed on an inner surface of the insertion hole continuously with the joint portion, the expanding diameter portion having a diameter expanding outward in a radial direction of the shaft and separated more from the outer circumferential surface of the protrusion as the expanding diameter portion extends away from the joint portion.

2. The rotating body according to claim 1, wherein the joint portion and the entry portion have different inner diameters.

3. The rotating body according to claim 1, wherein a portion of an outer wall of the insertion hole where the joint portion and the expanding diameter portion are formed on the inner surface extends longer in an axial direction of the shaft than a thickness in the radial direction of the shaft.

4. The rotating body according to claim 2, wherein a portion of an outer wall of the insertion hole where the joint portion and the expanding diameter portion are formed on the inner surface extends longer in an axial direction of the shaft than a thickness in the radial direction of the shaft.

5. The rotating body according to claim 1, further comprising:
an abutment portion provided in the insertion hole and extending in the radial direction of the shaft; and
a contact portion formed in the protrusion and contacting the abutment portion in the axial direction of the shaft.

6. The rotating body according to claim 2, further comprising:
an abutment portion provided in the insertion hole and extending in the radial direction of the shaft; and
a contact portion formed in the protrusion and contacting the abutment portion in the axial direction of the shaft.

7. The rotating body according to claim 3, further comprising:
an abutment portion provided in the insertion hole and extending in the radial direction of the shaft; and
a contact portion formed in the protrusion and contacting the abutment portion in the axial direction of the shaft.

8. The rotating body according to claim 4, further comprising:
an abutment portion provided in the insertion hole and extending in the radial direction of the shaft; and
a contact portion formed in the protrusion and contacting the abutment portion in the axial direction of the shaft.

9. The rotating body according to claim 4, wherein the abutment portion is provided between the joint portion and the entry portion.

10. The rotating body according to claim 5, wherein the abutment portion is provided between the joint portion and the entry portion.

11. The rotating body according to claim 6, wherein the abutment portion is provided between the joint portion and the entry portion.

12. The rotating body according to claim 7, wherein the abutment portion is provided between the joint portion and the entry portion.

13. The rotating body according to claim 8, wherein the abutment portion is provided between the joint portion and the entry portion.

14. The rotating body according to claim 1, wherein an outer diameter of a portion of the protrusion located radially inward from the entry portion is larger than an outer diameter of a portion having a smallest diameter in a portion of the protrusion of the protrusion located radially inward from the joint portion.

15. A turbocharger comprising the rotating body according to claim 1.
